(19) United States
(12) Patent Application Publication
(10) Pub. No.: US 2016/0121347 A1
(43) Pub. Date: May 5, 2016

(54) SPRAY GUN AND SPRAY METHOD

(71) Applicant: AXALTA COATING SYSTEMS IP CO., LLC, Wilmington, DE (US)

(72) Inventor: Bert DELSARD, Westerlo (BE)

(73) Assignee: AXALTA COATING SYSTEMS IP CO., LLC, Wilmington, DE (US)

(21) Appl. No.: 14/896,140

(22) PCT Filed: Jun. 10, 2014
(86) PCT No.: PCT/IB2014/001011

§ 371 Date: Dec. 4, 2015

Related U.S. Application Data
(60) Provisional application No. 61/832,192, filed on Jun. 7, 2013.
(60) Provisional application No. 61/832,194, filed on Jun. 7, 2013.

(51) Int. Cl. B05B 7/08; B05D 1/02; B05D 7/00; B05B 7/24

(52) U.S. Cl. CPC B05B 7/0815; B05B 7/2429; B05D 1/02; B05D 7/53

(57) ABSTRACT

This description is directed to a spray gun comprising a spray gun body, an air cap, a fluid spray nozzle having a fluid tip, at least one air distribution channel for atomizing air and at least one air distribution channel for fan air, wherein the fluid spray nozzle and the air cap are configured to direct an atomization airflow at an angle of about 10 to about 70 degrees into the coating composition jet, and the fluid spray nozzle and the air cap are configured to provide an atomizing air pressure to fan air pressure ratio of about 0.1 to about 10. The description is also directed to the use of the spray gun for applying water-based coating compositions, a method for producing a coating layer over a substrate with a coating composition, and a method for applying a layer of a water-based coating composition onto a substrate.

### CROSS-REFERENCE TO RELATED APPLICATIONS

This application is a U.S. National-Stage entry under 35 U.S.C. §371 based on International Application No. PCT/IB2014/001011, filed Jun. 10, 2014, which was published under PCT Article 21(2) and which claims priority to U.S. Provisional Application No. 61/832,192, filed Jun. 7, 2013, and claims priority to U.S. Provisional Application No. 61/832,194, filed Jun. 7, 2013, which are all hereby incorporated in their entirety by reference.

### TECHNICAL FIELD

The technical field is directed to a spray gun particularly suited for applying water-based coating compositions, and to the use of the spray gun for applying water-based coating compositions, specifically water-based clear coat and top coat coating compositions and to a method for applying a layer of a water-based coating composition onto a substrate by a spray gun.

### BACKGROUND

Against the background of increasingly stringent environmental legislation, water-based paints have become more and more important in recent years in various fields of application, including, vehicle coating and vehicle refinish coating. Vehicle refinish coating compositions are typically applied onto the substrate, i.e. the automobile vehicle body or body parts, using a manual spray gun and then cured to form the final coating layer.

Two-component isocyanate-curing coating compositions for vehicle refinish coating have to have a high physical drying rate and, on the other hand, the paint film should be free from surface defects, such as popping marks, be high gloss and at high level of appearance. A high run or sag limit is also required. In two-component water-based coating compositions, reaction bubbles caused by the reaction of isocyanate with water also have to be avoided. To achieve good physical drying specific water-reducible binders have been developed for the water-based coating compositions. However, the use of these specifically developed binders still leads to a low popping limit of the applied coating, i.e. flaws such as popping marks are produced even at a relatively low film layer thickness of about 40 μm. Also, air entrapment in the coating film often leads to surface defects.

Therefore, the object of the present description was to provide a spray gun, specifically a manual spray gun for water-based coating compositions, specifically for isocyanate-curing two-component water-based coating compositions, and to provide a method for applying water-based coating compositions, which spray gun and method allows applying paint films with good visual appearance, i.e. paint films that are free from surface defects such as popping marks, even at relatively high dry film layer thickness of, for example, 60 or 70 to 90 μm and above. In addition, other objects, desirable features and characteristics will become apparent from the subsequent summary and detailed description, and the appended claims, taken in conjunction with the accompanying drawings and this background.

### BRIEF SUMMARY

This description is directed to a spray gun, specifically a manual spray gun, particularly suited for applying a layer of a water-based coating composition onto a substrate, said spray gun comprising a spray gun body (1), an air cap (2), a fluid spray nozzle (3) having a fluid tip (4) and at least one air distribution channel for the atomizing air (8) and at least one air distribution channel for the fan air (9),

wherein the spray gun is characterized in that:

A) the fluid spray nozzle and the air cap are configured to direct an atomization airflow at an angle of about 10 to about 70 degrees, preferably about 15 to about 60 degrees, preferably of about 30 to about 45 degrees, relative to the coating composition jet, into the coating composition jet, and

B) the fluid spray nozzle and the air cap are configured to provide an atomizing air pressure to fan air pressure ratio of about 0.1 to about 10, preferably about 0.5 to about 1.0, preferably of about 0.6 to about 0.9.

The atomizing air pressure is preferably about 2.0 to about 4.0 bar and the fan air pressure is preferably about 2.0 to about 4.0 bar, measured at the air cap outlet.

This disclosure is also directed to a method for producing a coating layer over a substrate with a coating composition, which can be any type of coating composition. The method can comprise the steps of:

atomizing the coating composition from a fluid spray nozzle and air cap assembly comprising an air cap and a fluid spray nozzle having a fluid tip orifice, to form an atomized coating composition jet by directing an atomizing air to form an atomization air flow evenly in a rotational symmetry around the rotational axis Z-Z′ of the fluid spray nozzle and all around the fluid tip orifice at an atomization air flow angle in a range of from about 10 to about 70 degrees, relative to the rotational axis Z-Z′; and

spraying the atomized coating composition jet over the substrate to form a wet coating layer.

For both the spray gun embodiments and the method embodiments of the present description the different values regarding the airflow angle and the atomizing air pressure to fan air pressure ratio disclosed herein can be combined. Particularly, the values of angles of about 10 to about 70 degrees, about 15 to about 60 degrees, and of about 30 to about 45 degrees can be combined with the atomizing air pressure to fan air pressure ratio values of about 0.1 to about 10, about 0.5 to about 1.0, and of about 0.6 to about 0.9.

The coating layer can be produced with the spray gun of this disclosure.

The wet coating layer can be dried or cured to form a dry coating layer, at an ambient temperature in a range of from about 10° C. to about 70° C., at an elevated temperature in a range of from about 70° C. to about 300° C., or a combination thereof. The wet coating layer can be dried or cured at a temperature in a range of from about 10° C. to about 70° C. in one example, about 10° C. to about 60° C. in another example, about 10° C. to about 50° C. in yet another example, about 10° C. to about 40° C. in yet another example, about 10° C. to about 30° C. in yet another example, and about 10° C. to about 20° C. in a further example. In an even further example, the wet coating layer can be first cured or dried at an ambient temperature and then baked at an elevated temperature.

This description is further directed to a method for applying a layer of a water-based coating composition onto a substrate by a spray gun, in particular by a manual spray gun, said method comprising the steps of:

(1) providing a spray gun, in particular a manual spray gun, said spray gun comprising a spray gun body (1), an air cap (2), a fluid spray nozzle (3) having a fluid tip (4), at least one air distribution channel for atomizing air (8) and at least one air distribution channel for fan air (9), wherein the spray gun is characterized in that:

A) the fluid spray nozzle and the air cap are configured to direct an atomization airflow at an angle of about 10 to about 70 degrees, preferably about 15 to about 60 degrees, preferably of about 30 to about 45 degrees, relative to the coating composition jet, into the coating composition jet, and

B) the fluid spray nozzle and the air cap are configured to provide an atomizing air pressure to fan air pressure ratio of about 0.1 to about 10, preferably about 0.5 to about 1.0, preferably of about 0.6 to about 0.9,

(2) applying at least one layer of the water-based coating composition onto the substrate by said spray gun, wherein the water-based coating composition is applied with an atomizing air pressure to fan air pressure ratio of about 0.1 to about 10, preferably about 0.5 to about 1.0, preferably of about 0.6 to about 0.9.

The water-based coating composition is applied with an atomizing air pressure of preferably about 2.0 to about 4.0 bar and a fan air pressure of preferably about 2.0 to about 4.0 bar, measured at the air cap outlet.

### BRIEF DESCRIPTION OF DRAWINGS

The present embodiment will hereinafter be described in conjunction with the following drawing figures, wherein like numerals denote like elements, and:

FIG. 1 shows side views of representative examples of the spray gun. FIG. 1A is a representative example of the spray gun having a coating cup affixed at the upper side of the spray gun. FIG. 1b is a representative example of the spray gun having a coating cup affixed at the lower side of the spray gun. FIG. 1C is a representative example of a pressure fed version of the spray gun. The coating composition is supplied to the spray gun via a connection hose that leads, for example, to a pressure pot, a circulation system, or a pump.

FIG. 1 shows a schematic presentation of a typical manual spray gun with spray gun body (1), air cap (2), fluid spray nozzle (3), fluid tip (4), air distribution channels (5a, 5b), paint cup (11) and inlet air channel (12).

FIG. 2 shows representative examples of cross-sectional views of the air cap and fluid spray nozzle assembly (A) and (B). FIGS. 2A and 2B show two different embodiments of a fluid spray nozzle (3)/air cap (2) assembly according to an embodiment or which can be used in the method of this description with separate atomizing air distribution channel (8) providing atomizing airflow to the air cap openings and fan air distribution channel (9), providing fan airflow to the air cap horn openings.

FIG. 3 shows representative examples of cross-sectional views of the air cap and fluid spray nozzle assembly in a spraying configuration with the spray needles at an open position. FIG. 3A shows the embodiment of FIG. 2A in operation with paint jet (14), i.e., coating composition jet, atomizing airflow (8) and (13) and fan airflow (15). It should be noted that in FIG. 3A and FIG. 7A, the air cap should be understood to seal, i.e. to sit on, the nozzle as it is shown in FIG. 2A, so that atomizing air that goes in via the bores 6 cannot escape and mix with fan air. FIG. 3B shows the embodiment of FIG. 3A in operation.

FIG. 4 shows representative examples, where FIG. 4A illustrates a cross-sectional view of the air cap, FIG. 4B illustrates a frontal perspective view of the air cap, FIG. 4C a cross-sectional view of the air cap and fluid spray nozzle assembly, and FIGS. 4D and 4E illustrated examples of suitable configurations of the air cap. FIG. 4A shows one embodiment of an air cap (2) with horns (10) and fan air channel (9) and an atomizing air channel (8). In a particular embodiment an angle paint jet, i.e., coating composition jet/atomizing air flow of 45 degrees is used.

FIG. 5 shows representative examples, FIG. 5A is a side view, FIG. 5B is a cross-sectional view, and FIG. 5C is a perspective view of the of the fluid spray nozzle. FIG. 5 shows one embodiment of a 45 degrees fluid spray nozzle (3) with fluid tip orifice (4) and atomizing air bores (6).

FIGS. 6A, 6B, and 6C 6 show representative cross-sectional views of examples of the fluid spray nozzle in a non-spraying configuration with the spray needle at the closed position and an example of a fluid spray nozzle having a tip rim is shown in FIG. 6D. FIG. 6 shows different embodiments of a fluid spray nozzle (3) with needle (7) and bores (6) for the atomizing air. In a further particular embodiment an angle paint jet/atomizing air flow of 45 degrees is used.

FIG. 7 shows representative examples of schematic presentations of directions of coating composition jet, atomization air flow, and fan air flow with FIG. 7A illustrating a cross-sectional view of the air cap and fluid spray nozzle assembly, FIG. 7B illustrating a detailed view of the orifice and air cap spray opening, and FIG. 7C illustrating a schematic representation of the rotational symmetry and the atomization air flow angle (41) between the atomization air flow (8) and the rotational axis Z-Z′. FIG. 7 shows a schematic presentation of a direction of the atomization air flow (8) into the coating composition jet (14) of 45 degrees and of a direction of the atomization air flow into the coating composition jet (14) of 30 degrees.

FIGS. 8A-8C show measurement data.

### DETAILED DESCRIPTION

The features and advantages of the present embodiments will be more readily understood, by those of ordinary skill in the art, from reading the following detailed description. It is to be appreciated that certain features of the disclosure, which are, for clarity, described above and below in the context of separate embodiments, may also be provided in combination in a single embodiment. Conversely, various features of this description that are, for brevity, described in the context of a single embodiment, may also be provided separately or in any sub-combination. In addition, references in the singular may also include the plural (for example, “a” and “an” may refer to one, or one or more) unless the context specifically states otherwise.

Water-based coating compositions are coating compositions, wherein water is used as solvent or thinner when preparing and/or applying the coating composition. Usually, aqueous coating compositions contain about 20 to about 80% by weight of water, based on the total amount of the coating composition and optionally, up to about 15% by weight, preferably, below about 10% by weight of organic solvents, based on the total amount of the coating composition.

The spray gun of this description or which can be suitable in the method of the present description is particularly suited as a manual (or hand-held) spray gun. A manual spray gun is a spray gun which is used manually by a human, i.e. a coating composition is manually sprayed with the spray gun by a human. A manual spray gun is not a spraying device used in or as a spraying robot or a spraying machine or robot or handled by a spraying machine or spraying robot. Manual spray guns are typically used for applying coating compositions in vehicle refinishing, particularly in vehicle repair coating in refinish body shops. However, the spray gun of the present description can also be used in a spraying robot or a spraying machine or can be handled by a spraying robot or a spraying machine.

Atomizing air (AA) is defined as the airflow or air volume that breaks the liquid paint jet, which will be used hereinafter synonymously with coating composition jet, coming from the fluid tip of the fluid spray nozzle, into small droplets. Fan air (FA) is defined as the airflow or air volume that pushes the atomized paint jet into a desired paint jet form, such as a spherical form, preferably an elliptical cone.

The spray gun of the present description or which can be used in the method of the present description is operable by high air volume and high air pressure, measured at the air cap outlet.

Air volumes of, for example, about 501/min to about 6001/min, preferably about 1001/min to about 6001/min, preferably about 2001/min to about 5001/min, measured at the air cap outlet, can be used. Atomizing air volume and fan air volume can be controlled separately in the range of about 501/min to about 6001/min, preferably about 1001/min to about 5001/min. A respective input air volume has to be selected accordingly.

The atomizing air pressure can be, for example, in the range of about 0.5 to about 5.0 bar, preferably about 1.0 to about 5.0 bar, preferably about 2.0 to about 4.0 bar, measured at the air cap outlet. The fan air pressure can be, for example, in the range of about 0.5 to about 5.0 bar, preferably about 1.0 to about 5.0 bar, preferably about 2.0 to about 4.0 bar, measured at the air cap outlet. Accordingly an input air pressure of, for example, about 2.0 to about 12.0 bar is needed. Respective input air pressure can be obtained by using a turbine compressor.

The spray stream or coating composition jet is produced by using a pressurized carrier. Even if compressed air is preferably used and referred to throughout the present description other pressurized carriers, such as compressed gas different from air or a compressed gas mixture, can be used, too.

Surprisingly it has been found that the spray gun and the method of the present description with the features as defined in the independent claims allow to improve atomization of water-based coating compositions (the coating fluid) and thus, avoids air entrapment in the coating film applied with the spray gun to a remarkable extent, and improves air release out of the applied coating film. As a result appearance of the coating film applied is improved. Popping resistant coating films up to a dry film thickness of, e.g., about 60-90 μm and above (e.g. about 60-120 μm) can be achieved, while this is not possible with existing VOC compliant manual spray guns.

The spray gun of the present description or a spray gun which can be used in the method of the present description has a fluid spray nozzle and an air cap which are both configured to direct an atomization air flow at an angle of about 10 to about 70 degrees, preferably about 15 to about 60 degrees, preferably of about 30 to about 45 degrees (relative to the coating composition jet) into the coating composition jet. With other words the fluid spray nozzle and the air cap are both configured such, that the angle formed by the central axis of the coating composition jet and the central axis of the atomization air flow is about 10 to about 70 degrees, preferably about 15 to about 60 degrees, preferably about 30 to about 45 degrees. The central axis of the coating composition jet is in a 90 degree angle relative to the fluid tip surface or laminar to the fluid tip opening.

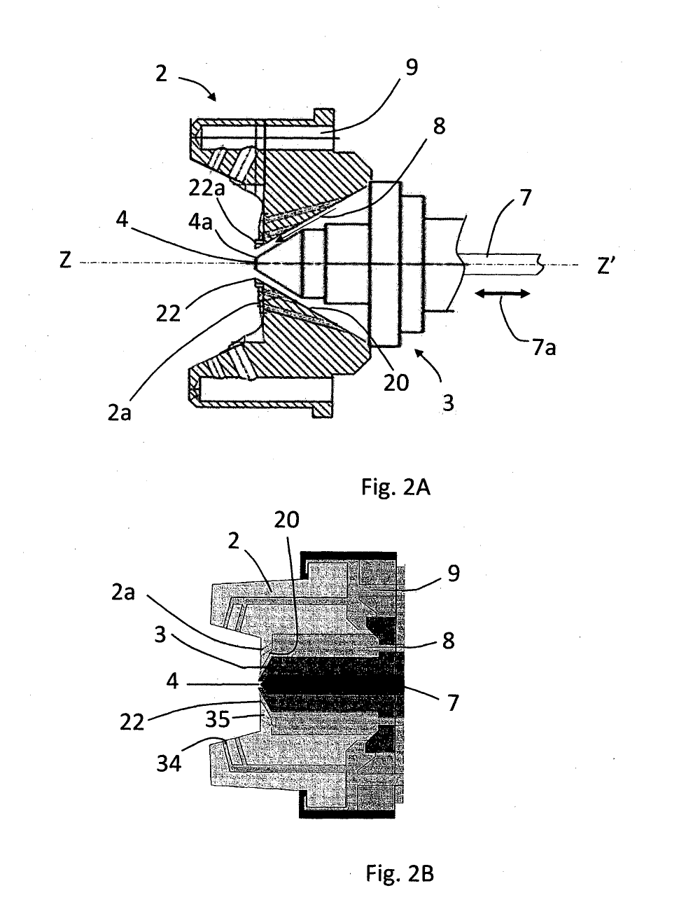

Accordingly the fluid spray nozzle is configured such that it has the form of a about 10 to about 70 degree, preferably about 15 to about 60 degree, preferably about 30 to about 45 degree cone terminating to a about 10 to about 70 degree, preferably about 15 to about 60 degree, preferably about 30 to about 45 degree angular fluid tip. Accordingly the air cap is formed with a central about 10 to about 70 degree, preferably about 15 to about 60 degree, preferably about 30 to about 45 degree angular air aperture (opening). The profile of the fluid spray nozzle being a about 10 to about 70 degree, preferably about 15 to about 60 degree, preferably about 30 to about 45 degree frustum, terminating at the about 10 to about 70 degree, preferably about 15 to about 60 degree, preferably about 30 to about 45 degree angular fluid tip, through which the water-based coating composition is discharged (see FIGS. 2 to 4).

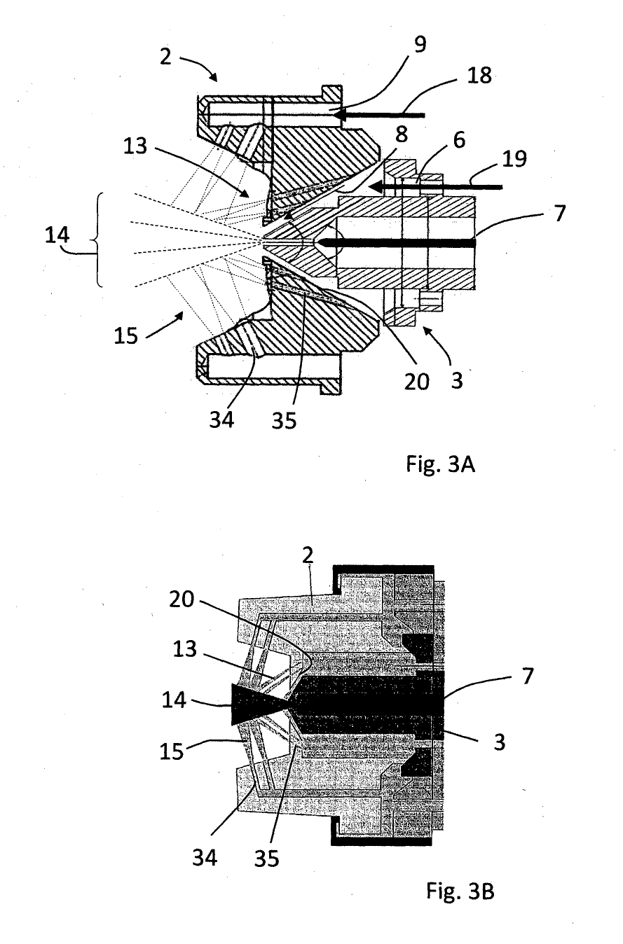

During operation of the spray gun a flow of atomizing air emerges through the gap between the fluid spray nozzle and the air cap. This atomizing airflow hits the paint jet, i.e., the coating composition jet, coming out of the fluid tip of the nozzle (which has a conical form—see FIG. 3) and breaks the paint jet, i.e., the coating composition jet, up into atomized droplets. If desired the paint jet of this and every other embodiment can be conical. In other words it changes the coating composition jet into an atomized fluid stream of fine droplets. The atomized paint jet can be corrected to a very stable and very homogeneous spray cone by applying the correct fan air flow. During operation of the spray gun preferably about 80 to about 99%, more preferred about 90 to about 100% of the total atomization air volume is directed at an angle of about 10 to about 70 degrees, preferably, about 15 to about 60 degrees, preferably of about 30 to about 45 degrees (relative to the coating composition jet) into the coating composition jet. Accordingly fluid spray nozzle and air cap can contain additional bores to direct the remaining part of the atomization air volume.

Generally the fluid spray nozzle and the air cap of a spray gun form a unified system, i.e. a specific fluid spray nozzle requires a specific air cap configured to match, for example, the opening of the air cap has to be adjusted according to the diameter of the fluid tip of the nozzle.

The fluid spray nozzle and the air cap of the spray gun, together with the air distribution channels, are configured to provide an atomizing air pressure to fan air pressure ratio (AA/FA ratio) of about 0.1 to about 10, preferably about 0.5 to about 1.0, preferably of about 0.6 to about 0.9, measured at the air cap outlet. The AA/FA ratio can be, for example, about 2 bar:3 bar to about 2.5 bar:3 bar. The design of the fluid spray nozzle and the air cap can be configured in different ways in order to ensure the desired AA/FA ratio. The fluid spray nozzle and the air cap contain at least one air channel for the atomizing air (8) and at least one air channel for the fan air (9). According to one embodiment the diameter of the air channels can be selected such that the desired AA/FA ratio can be adjusted in the operation status of the spray gun. According to a further embodiment means can be included for regulating the air flow volumes (and accordingly the air pressure) in the separate air channels at given air channel diameters. Air flow volumes can be regulated, for example, by air valves. Also, according to yet a further embodiment both of the above measures, the air channel diameter and the regulation of the air flow volume by respective means can be used. Selection of appropriate air channel diameters and air flow volume regulating means can be made according to the knowledge of a person skilled in the art.

In addition the fluid spray nozzle or the air cap or both may contain bores to direct the atomization or the fan air flow. Number, diameter and position of the respective bores are selected according to the knowledge of a person skilled in the art in order to achieve the desired air volume and air pressure.

The manual spray gun of the present description comprises the spray gun body (1), the air cap at the front of the spray gun body (2) and the fluid spray nozzle (3). The air cap is formed with horns (10) in order to supply the fan air. The spray gun comprises at least two air distribution channels, one for the atomizing air (8) and one for the fan air (9). According to one embodiment the compressed air enters the spray gun body via an inlet air channel (12), e.g. a central inlet air channel. The inlet air channel is separated into the at least one atomizing air channel and at least one fan air channel.

According to a further embodiment the incoming compressed air may directly be divided at the air inlet into at least one atomization air stream and at least one fan air stream. The air distribution channels have to be configured accordingly. Preferably the spray gun comprises a compressed air distribution system that means, it comprises at least one compressed air inlet channel and two separate air distribution channels—one for the atomization air and one for the fan air. So the spray gun body preferably contains means dividing the incoming air into a first air flow that provides atomizing air around the fluid spray nozzle and into a second air flow that provides the fan air to the horns of the air cap. One or more air channels for the atomizing and the fan air may be present.

Separation and regulation of the compressed input air into atomizing air and fan air can be realized by means of air valves regulating independently the atomizing and fan air volume (and accordingly the air pressure).

According to a further embodiment the spray gun can have in addition pressure valves and digital read out on the separate air channels, regulating separately the atomizing air flow and fan air flow to set the desired ratio AA/FA, measured at the air cap outlet. According to yet another embodiment the spray gun can be connected to a pressurized paint (coating composition) supply which can be a standalone pressure pot, a paint pump or a pressurized paint cup on the gun body, wherein the pressure can be applied via a relief valve by an auxiliary air supply connected to the spray gun air passages. An air pressure on the paint cup can be required of, e.g., about 0.1 to about 6 bar or of about 0.1-1.5 bar for the necessary paint flow, depending on the fluid tip diameter and angle in which the atomization air stream is directed into the paint jet.

The fluid spray nozzle can have a fluid tip opening diameter of about 0.1 to about 5 mm or of about 0.7 to about 2.5 mm.

The spray gun body can have additional multiple parts and controls, as typically used in manual spray guns, for example, a flow regulator for regulating the flow of the coating composition, and other mechanisms necessary for proper operation of a manual spray gun known to those skilled in the art. Typically, multiple channels, connectors, connection paths and mechanical controls can be assembled within the spray gun body.

The previously described design of the fluid spray nozzle and the air cap, in combination with the separate at least one atomizing air channel and the at least one fan air channel, allow to adjust the desired AA/FA pressure ratio and to direct the atomization air flow at the desired angle into the coating composition jet.

The present description also relates to a fluid spray nozzle/air cap assembly, wherein A) the fluid spray nozzle and the air cap are configured to direct an atomization air flow at an angle of about 10 to about 70 degrees, preferably about 15 to about 60 degrees, preferably of about 30 to about 45 degrees, relative to the coating composition jet, into the coating composition jet, and B) the fluid spray nozzle and the air cap are configured to provide an atomizing air pressure to fan air pressure ratio of about 0.1 to about 10, preferably about 0.5 to about 1.0.

The details, embodiments and preferred embodiments of the fluid spray nozzle and the air cap of the fluid spray nozzle/air cap assembly are the same as described above for the fluid spray nozzle and the air cap as part of the spray gun. The fluid spray nozzle/air cap assembly can be used in any type of spray gun, for example in a manual spray gun, but also in a spraying robot or a spraying machine, and in any other spraying device.

In step (2) of the method of the present description a layer of a water-based coating composition is applied onto the substrate by the above described spray gun, wherein the water-based coating composition is applied with an atomizing air pressure to fan air pressure ratio of about 0.1 to about 10, preferably about 0.5 to about 1.0, preferably of about 0.6 to about 0.9.

The spray gun and the fluid spray nozzle/air cap assembly and the method of the present description can specifically be used for applying water-based coating compositions. Typical water-based coating compositions comprise binders, optionally cross-linkers, and a liquid carrier. The liquid carrier is water and may comprise in addition one or more organic solvents. Binders are, for example, compounds with functional groups with active hydrogen. These compounds can be oligomeric or polymeric binders. In order to ensure sufficient water dilutability of the binders they are modified to render them hydrophilic, e.g., they can be anionically modified by incorporation of acid groups. The water-based coating compositions can contain cross-linkers, for example, polyisocyanates with free isocyanate groups. Examples of polyisocyanates are any number of organic di- or higher functional isocyanates with aliphatically, cycloaliphatically, araliphatically and/or aromatically bound free isocyanate groups. The polyisocyanate cross-linkers are those commonly used in the paint industry, and are described in detail in the literature and are also obtainable commercially.

The water-based coating compositions can contain pigments, solid pigments as well as effect pigments, fillers and/or usual coating additives. Examples of usual coating additives are light stabilizers, for example, based on benztriazoles and HALS (hindered amine light stabilizer) compounds, flow control agents based on (meth)acrylic homopolymers or silicon oils, rheology-influencing agents, such as, highly disperse silicic acid or polymeric urea compounds, thickeners, such as, cross-linked polycarboxylic acid or polyurethanes, anti-foaming agents, wetting agents.

The water-based coating compositions to be applied with the spray gun and the fluid spray nozzle/air cap assembly and with the method of this description can be any kind of paints such as waterborne clear coats, water-borne top coats, water-borne base coats and water-borne primers.

The water-based coating composition can be applied onto a pre-coated substrate. Suitable substrates are metal and plastics substrates, in particular the substrates known in the automotive industry, such as for example iron, zinc, aluminum, magnesium, stainless steel or the alloys thereof, together with polyurethanes, polycarbonates or polyolefins. In case of a multilayer coating with water-based base coat composition and water-based clear coat composition the clear coat layer may be applied onto the base coat layer either after drying or curing or wet-on-wet, optionally after briefly flashing off. The water-based coating compositions may comprise one-component or two-component coating compositions. Once the layer of the water-based coating composition has been applied, it may initially be flashed off to remove water and optionally present organic solvent. Curing may then proceed at ambient temperature or thermal curing may proceed at temperatures of, for example, about 40 to about 140° C., specifically at about 40 to about 60° C.

Applying water-borne coating compositions with the spray gun and the fluid spray nozzle/air cap assembly and the method of the present description creates spray patterns with uniform dry film thickness distribution within the paint layer. For example, the popping and sagging limit of e.g. water-based clear coats improves significantly versus a manual spray gun of the prior art using normal air caps, such as the SATA RP 3000 1.2 or the SATA RP 4000 1.2. spray gun from SATA. Air entrapment can be remarkably reduced and air release can be improved. Consequently appearance can significantly be improved.

Appearance improves even more when in a multilayer coating process with application of water-based basecoat composition and water-based clear coat composition the water-based basecoat composition as well as the water-based clear coat composition are applied with the spray gun and the fluid spray nozzle/air cap assembly of the present description. Also, in a multilayer coating with water-based effect basecoat composition and water-based clear coat composition the flop or flop effect of the effect coating can be remarkably improved.

The spray gun and the fluid spray nozzle/air cap assembly for applying water-based coating composition and the method can preferably be used in vehicle repair coating, but also in an original vehicle production line painting as well as for coating large vehicles and transportation vehicles, such as trucks, busses and railroad cars. So the substrates to be coated or repair coated are preferably vehicle bodies or vehicle body parts. However, the spray gun can also be used for applying water-based coating compositions onto other substrates in other fields of application, for example, onto wood, plastic, leather, paper and other metal substrates as well as onto woven and nonwoven fabrics.

The spray gun can comprise a spray gun body (1), a fluid spray nozzle and air cap assembly comprising an air cap (2), a fluid spray nozzle (3) having a fluid tip orifice (4), at least one atomization air distribution channel (6) for distributing an atomizing air (19), and at least one fan air distribution channel (9) for distributing a fan air (18), wherein the spray gun can be characterized in that:

A) the fluid spray nozzle and air cap assembly is configured to direct the atomizing air (19) to form an atomization air flow (8) evenly in a rotational symmetry around the rotational axis Z-Z′ of the fluid spray nozzle and all around the fluid tip orifice (4) at an atomization air flow angle (41) in a range of from about 10 to about 75 degrees, relative to the rotational axis Z-Z′.

The spray gun can be further characterized in that:

B) the atomizing air (19) and the fan air (18) are provide an atomizing air pressure to a fan air pressure ratio of about 0.1 to about 10.

The atomizing air pressure and air volume stream as well as the fan air pressure and air volume stream can be regulated by the nozzle and air cap design. The atomizing air pressure and the fan air pressure can be regulated by configuring relative sizes of the atomization air distribution channel (6) and the fan air distribution channel (9), using one or more regulators to regulate air supplied to the atomization air distribution channel (6) and the fan air distribution channel (9), providing separate pressurized air of the desired air pressures to the atomization air distribution channel (6) and the fan air distribution channel (9), or a combination thereof. The air distribution channel (6), there can be in a range of from 6-12 of such air distribution channels and the fan air distribution channels. The spray gun can be configured to provide in a range of from about 0.1 to about 600 liter/min, preferably from about 0.1 to about 500 liter/min air volume stream to the air cap opening (22) and in a range of from about 0 to about 500 liter/min air volume stream up to the fan air outlets (34). The diameter of the air cap opening (22) and the diameter of the air cap fan air outlets (34) can be sized to regulate the ratio of the atomizing air pressure and the fan air pressure in bar with a desired air volume to assure a desired spray pattern.

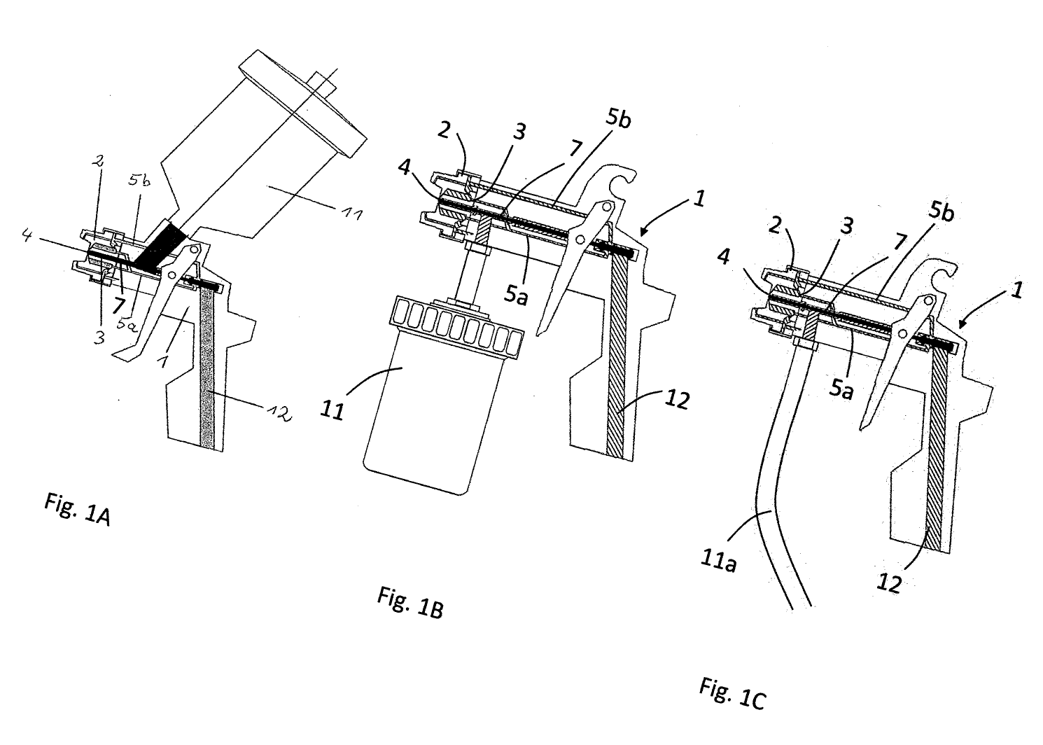

The spray gun can further comprise one or more air distribution channels (5a, 5b), paint cup (11) and inlet air channel (12) (FIG. 1A-1B). The paint cup (11) can be attached to the upper side of the spray gun body (FIG. 1A) or the underside of the spray gun body (FIG. 1B). The coating composition can also be fed into the spray gun via pressure, for example, by connecting to a pressure pot, a circulation system, or a pump, or through a pressure feeding connector (11a) (FIG. 1C).

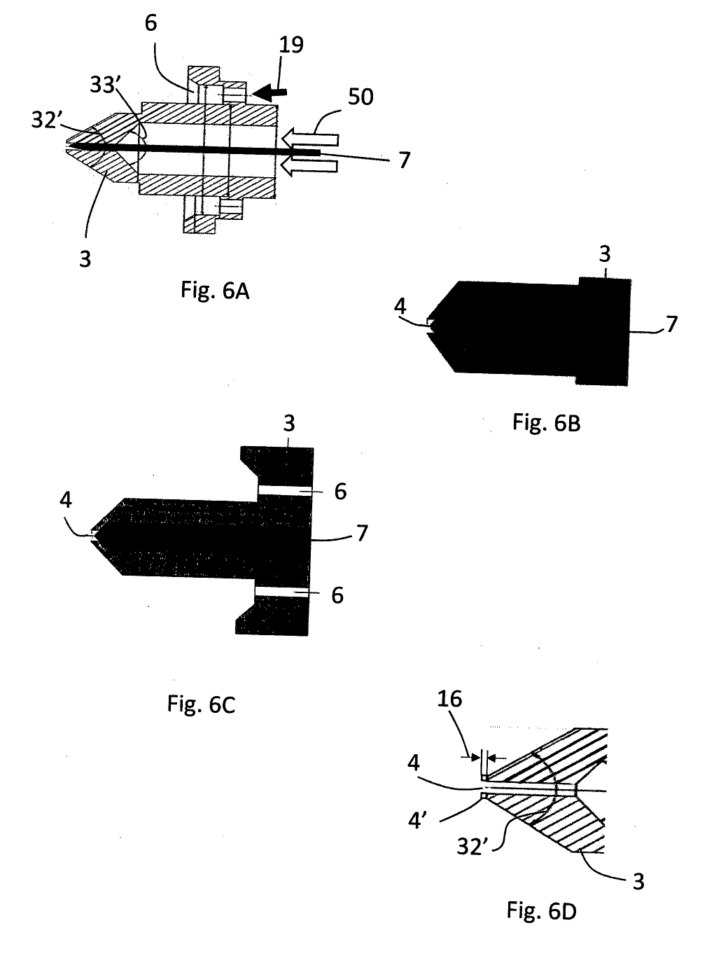

The fluid spray nozzle and the air cap can be assembled to form the fluid spray nozzle and air cap assembly via conventional mechanisms, such as matching screw tracks, clippers, or other mechanisms to assemble the parts. The fluid spray nozzle can have a spray needle (7) that slides along the rotational axis Z-Z′ of the fluid spray nozzle in the directions shown by the arrow (7a) between a closed position and an open position to close or open the fluid tip orifice (4) inside the fluid spray nozzle (FIG. 2A, FIG. 3 and FIG. 6), respectively. By controlling the position of the spray needle between the closed and the open positions, the amount of coating spraying through the fluid tip orifice can also be controlled. Once properly assembled, the fluid spray nozzle's fluid tip orifice can be positioned flush to the air cap spray opening (22). The external plane (22a) of the air cap spray opening (22) and the outmost tip plane of the fluid tip orifice (4a) are projected planes perpendicular to the rotational axis Z-Z′. The outmost tip plane of the fluid tip orifice (4a) can be protruding or recessing relative to the external plane (22a) of the air cap spray opening (22) in a range of from about 0 to about 2 mm in one example, about 0 to about 1 mm in another example, and about 0 to about 0.5 mm in yet another example. Representative examples of cross-sectional views of the fluid spray nozzle and air cap assemblies in spray operation configurations are shown in FIG. 3A-3B.

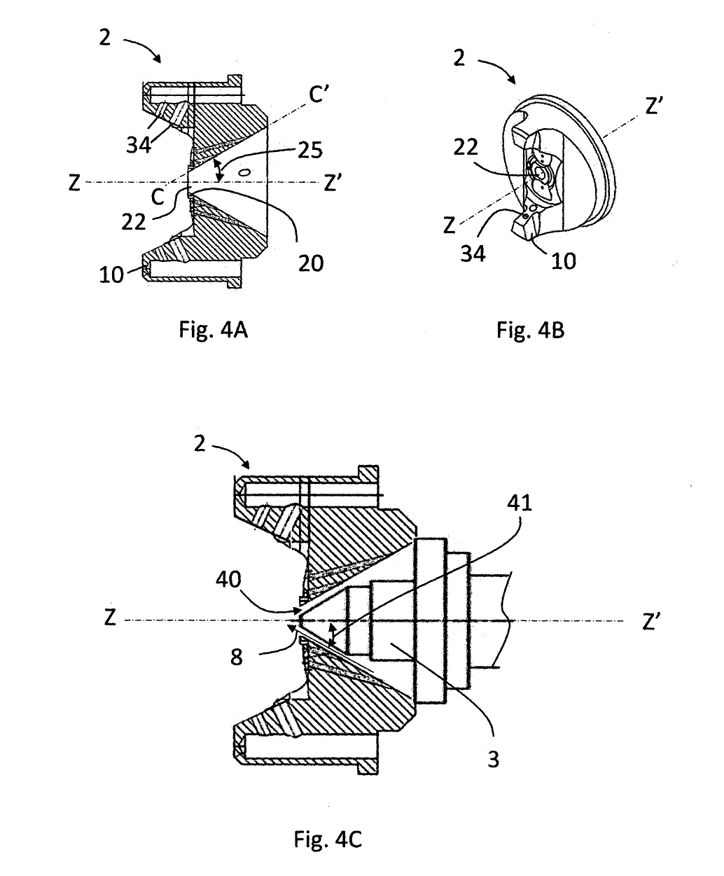

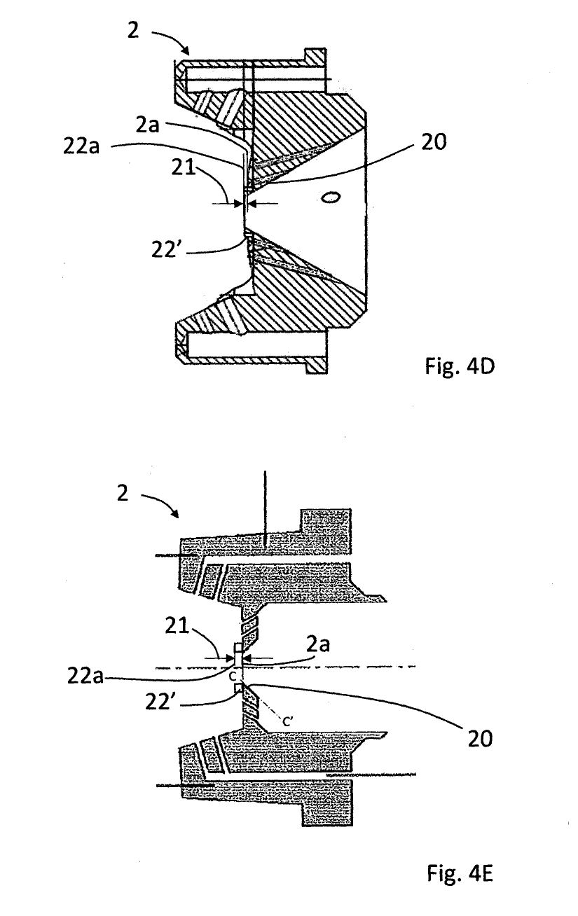

The air cap opening inner-surface (20) is a surface inside the air cap towards the fluid spray nozzle immediately around the air cap opening (22) and can be the entire (FIG. 2A, FIG. 3A and FIG. 4A-4D) or a portion (FIG. 2B, FIG. 3B and FIG. 4E) of the surface inside the air cap.

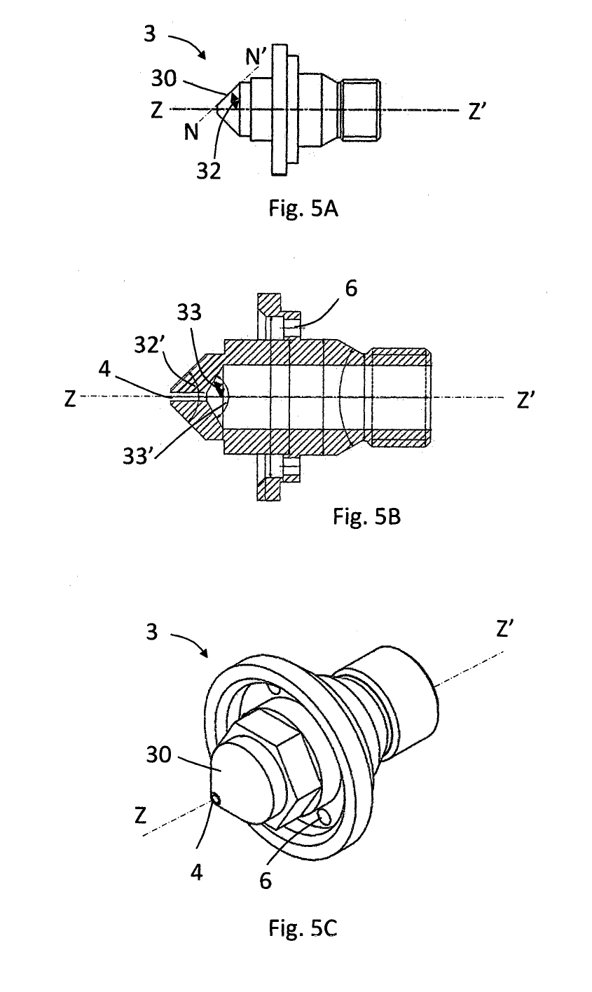

The atomization air flow is directed to flow through an atomizing air passage (40), a space formed by the air cap opening inner-surface (20) of the air cap (FIGS. 4A-4E) and the external nozzle surface (30) of the fluid spray nozzle (FIGS. 5A-5C) at the fluid tip orifice end of the fluid spray nozzle in a properly assembled fluid spray nozzle and air cap assembly. The air cap opening inner-surface (20) can be configured to have an air cap opening inner-surface angle (25) in a range of from about 10 to about 75 degrees, relative to the rotational axis Z-Z′. The air cap opening inner-surface angle (25) can be measured between an air cap opening inner-surface extension C-C′ and the rotational axis Z-Z′ on a perspective cross-section plane of the air cap intersecting the rotational axis Z-Z′ and parallel to the rotational axis Z-Z′ (FIGS. 4A and 4E). The external nozzle surface (30) is configured to have an external nozzle surface angle (32) in a range of from about 10 to about 75 degrees, relative to the rotational axis Z-Z′. The external nozzle surface angle (32) (FIG. 5A-5B) can be measured between an external nozzle surface extension N-N′ and the rotational axis Z-Z′ on a perspective cross-section plane of the fluid spray nozzle intersecting the rotational axis Z-Z′ and parallel to the rotational axis Z-Z′. The air cap opening inner-surface angle (25) and external nozzle surface angle (32) can be substantially the same, meaning that the difference in the air cap opening inner-surface angle (25) and the external nozzle surface angle (32) is less than about 66 degrees. The difference in the air cap opening inner-surface angle (25) and external nozzle surface angle (32) can be in a range of from about 0 to about 66 degrees in one example, about 0 to about 15 degrees in another example, about 0 to about 10 degrees in yet another example, about 0 to about 5 degrees in yet another example, and about 0 to about 2 degrees in a further example.

The fluid spray nozzle (3) can have a total external nozzle surface angle (32′) that is an angle defined by the external nozzle surface (30). The external nozzle surface (30) can be configured in a cone shape (FIG. 5C). The fluid spray nozzle can further configured to have an inner-nozzle surface having an inner-nozzle surface angle (33) measured from the inner-nozzle surface relative to the rotational axis Z-Z′. A total inner-nozzle surface angle (33′) is an angle defined by the inner-nozzle surface. The fluid spray nozzle (3) can comprise one or more atomization air distribution channels (6).

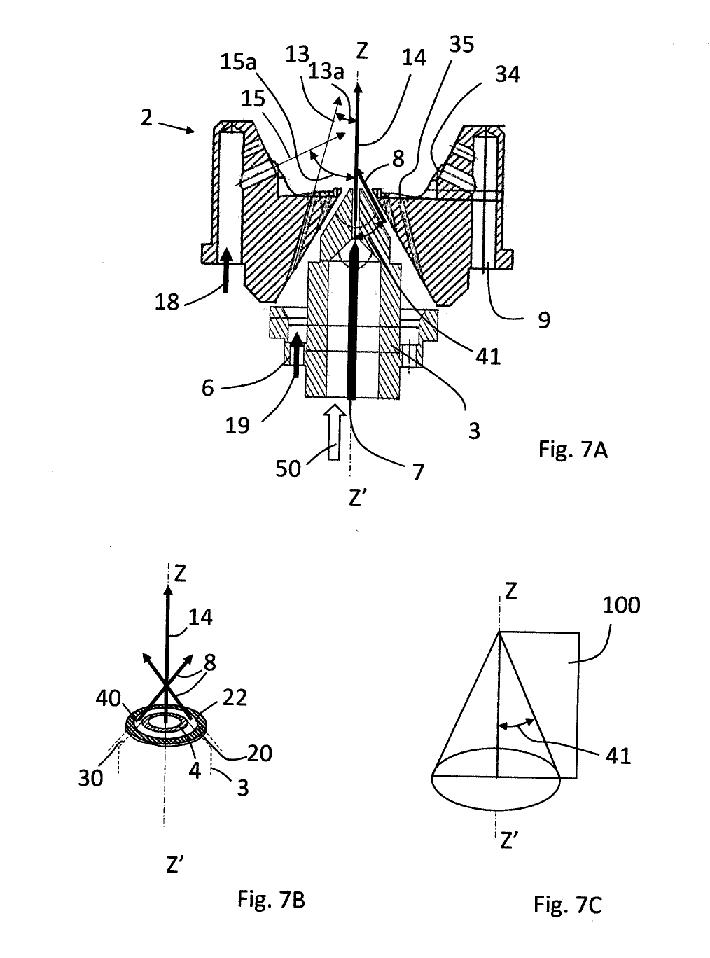

The air cap (2) can further comprise two or more fan air horns (10) (FIG. 4A-4B), each can have one or more fan air outlets (34). When in operation and supplied with the fan air (18) through the fan air distribution channel (9), the fan air outlets can be configured to deliver fan air jets (15) at a fan air jet angle (15a) in a range of from about 15 to about 89 degrees relative to the rotational axis Z-Z′ (FIG. 7A). The air cap can further comprise one or more supporting air channels (35) (FIG. 3). The fan air jets are used for shaping fan pattern of the coating composition jet (14). A fraction of the atomizing air (19) can be configured to jet through the supporting air channels (35) to form supporting air jets (13). The supporting air jets can be a fraction of the atomizing air, such as in a range of from about 0.01% to about 99% in one example, about 0.01% to about 50% in another example, about 0.01% to about 20% in another example, and about 0.01% to about 10% in yet another example, about 0.01% to about 5% in yet another example, percentage based on the air volumes of the supporting air jet and the atomizing air. The supporting air jets can help to keep the air cap and/or the horn clean and also provide air jets for shaping the fan shape of coating composition jet (14).

The fluid spray nozzle and air cap assembly is free from any structure disrupting or changing the atomization air flow (8) at the atomization air flow angle (41) (FIGS. 4A to 4C) around the fluid tip orifice (4) and the air cap spray opening (22) (FIGS. 2a and 2B). The fluid spray nozzle and air cap assembly is configured to direct the atomization air flow (8) at the atomization air flow angle (41). The fluid tip orifice can be configured to be at the immediate cone tip end of the fluid spray nozzle defined by a cone shaped external nozzle surface (30) with the outmost plane of the fluid tip orifice (4a) intersecting directly with the external nozzle surface (30). The air cap opening inner-surface (20) can directly intersecting with the external plane (22a) of the air cap spray opening (22). The fluid tip orifice can be configured to be at the immediate cone tip end of the fluid spray nozzle defined by a cone shaped external nozzle surface (30) (FIG. 5A) with the outmost tip plane of the fluid tip orifice (4a) intersecting directly with the external nozzle surface (30), and the air cap opening inner-surface (20) is directly intersecting with the external plane (22a) of the air cap spray opening (22).

FIG. 6 shows representative examples of details of the spray gun with the spray needle at a closed position within the fluid spray nozzle (FIG. 6A-6C). At the closed position, the coating (50) can be supplied to the fluid spray nozzle. However, no coating is sprayed out of the fluid tip orifice. The atomizing air (19) can be supplied independent from the coating (50). The fluid spray nozzle can have a tip rim (4′) (FIG. 6D). The tip rim can have a tip rim height (16), the distance between the outmost plane of the fluid tip orifice (4a) and the intersection point with the external nozzle surface (30), in a range of from about 0 to about 1.0 mm in one example, about 0 to about 0.8 mm in another example, about 0 to about 0.6 mm in yet another example, about 0 to about 0.4 mm in yet another example, about 0 to about 0.2 mm in yet another example, and about 0 to about 0.1 mm in a further example.

The air cap can have an air cap rim (22′) immediately around the air cap opening (22) (FIG. 4D-4E) with an air cap rim height (21) measured from the external plane (22a) of the air cap spray opening (22) to the air cap external surface (2a). The air cap rim height (21) can be in a range of from about 0 to about 1.0 mm. The air cap rim height (21) can be in a range of from about 0 to about 1.0 mm in one example, about 0 to about 0.8 mm in another example, about 0 to about 0.4 mm in yet another example, about 0 to about 0.2 mm in yet another example, and about 0 to about 0.1 mm in a further example.

FIG. 7 shows schematic presentations of the spray gun in a spraying configuration with the spray needle (7) at an open position allowing the coating (50) to spray out of the fluid tip orifice (4) to form the coating composition jet (14) along the direction of the rotational axis Z-Z′. The atomizing air (19) is supplied through the atomization air distribution channels (6) forming the atomization air flow (8) flowing through the atomizing air passage (40) and jetting out of the air cap spray opening (22) at the atomization air flow angle (41). The coating composition jet is atomized by the atomization air flow (8) after exiting the fluid tip orifice (4). The fan air (18) is supplied through the fan air distribution channels (9) and jets out of the fan air outlets (34) forming the fan air jets (15) at the fan air jet angle (15a) relative to the rotational axis Z-Z′. The supporting air jets (13) can be jetted out of the supporting air channels (35) at a supporting air jet angle (13a) relative to the rotational axis Z-Z′. The supporting air jet angle (13a) can be in a range of from about 10 to about 75 degree. The supporting atomization air jets (13) can give additional atomization and can prevent the atomized coating returning back to the air cap surface. The atomization air flow (8) can form a continuous cone shaped air flow around the fluid tip orifice (4) through the atomizing air passage (40) (FIG. 7B). The atomizing air flow (8) can impact the coating composition jet (14) causing the coating to atomize.

The atomization air flow angle (41) can be measured between the projected atomization air flow (8) and the rotational axis Z-Z′ of the fluid spray nozzle on a perspective cross-section plane (100) intersecting the rotational axis Z-Z′ and parallel to the rotational axis Z-Z′ (FIG. 7C). The atomization air flow angle (41) can be in a range of from about 10 to about 75 degrees in one example, about 10 to about 20 degree in another example, about 20-30 degree in yet another example, about 30 to about 40 degree in yet another example, about 40 to about 50 degree in yet another example, about 50 to about 60 in yet another example, and about 60 to about 75 degree in a further example. In a further example, the air cap and spray fluid nozzle assembly can have an external nozzle surface angles (32) at about 60 degree. In an even further example, the air cap and spray fluid nozzle assembly can have an external nozzle surface angle (32) at about 45 degree. In yet a further example, the air cap and spray fluid nozzle assembly can have an external nozzle surface angle (32) at about 30 degree.

The substrate can be coated with coating layers sprayed using the same or different spray guns. The substrate can be spray coated at a horizontal or a vertical position. The spray gun of this disclosure can be used to produce any coating layers on a substrate, such as a primer coating layer, a basecoat coating layer, a topcoat coating layer, a clearcoat coating layer, or a combination thereof. The spray gun of this disclosure can also be used to produce one or more additional coating layers on a substrate already coated with one or more coating layers. In one example, an article can be coating with one or more basecoat coat layers with any conventional spray gun and subsequently coated with one or more clearcoat coating layers with the spray gun of this disclosure. In another example, an article can be coated with one or more basecoat coating layers and one or more clearcoat coating layers with the spray gun of this disclosure.

Coating compositions suitable for using the spray gun of this disclosure can be any coating compositions that are suitable for spraying with a spray gun. The coating composition can be a solvent borne coating composition that comprises in a range of from about 10% to about 90% of one or more organic solvents, or a waterborne coating composition that comprises in a range of from about 20% to about 80% of water, percentage based on the total weight of the coating composition.

The coating composition can be a “two-pack coating composition”, also known as a 2K coating composition, with two components of the coating composition stored in separate containers and sealed to increase the shelf life of the components of the coating composition during storage. The coating composition can be a “one-pack coating composition”, also known as a 1K coating composition, such as a radiation curable coating composition or a coating composition that contains cross linkable components and blocked crosslinking components such as blocked isocyanates that can be deblocked under certain deblocking conditions.

The coating composition can be a mono-cure or a dual cure coating composition. A mono-cure coating composition can be cured by one curing mechanism. In one example, a mono-cure coating composition can contain one or more components having acrylic double bonds that can be cured by UV radiation in which the double bonds of the acrylic groups undergo polymerization to form a crosslinked network. In another example, a mono-cure coating composition can be cured by chemical crosslink and contain crosslinking groups and cross linkable groups that can react to form a crosslinked network. A dual-cure coating composition is a coating composition that can be cured by two curing mechanisms, such as UV radiation and chemical crosslink.

### Examples

### Comparative 1

A metal substrate, AL1050 A H14-24, was coated with 1 coat of an etch primer Standox Standofleet Wash Primer 1:1 Art. 4024669 932225/Zusatzlösung 4024669 937312, 15 minutes air dried and followed by 2 coats of a fill primer available from Standox VOC Nonstop Fill primer Art. 4024669 780635/3:1 with HS activator Stx HS 20-30 Art. 4024669 848809 and VOC thinner 4024669 780888. The system Wash primer+Nonstop Fill primer was baked for 30 minutes at 60 degrees Celsius. After cooling down to room temperature, the coated substrate was sanded with P500 sand paper and degreased with isopropanol. The coated panels were spray coated with a basecoat layer formed from Cromax® Pro jet black basecoat, under the respective trademarks, available from Axalta Coating Systems, Philadelphia, Pa., USA. The basecoat layer was spray with a Sata RP4000 1.2 spray gun and dried for 30 minutes in a spray booth at 23 C and 60% relative humidity (RH).

A clearcoat coating composition, HC300 Imron® HydroClear 2K waterborne clearcoat, activated with HT-202 activator with 3/1 ratio, under the respective trademark, available from Axalta Coating Systems, was spray coated over the above mentioned basecoat layer on the substrate using a Sata RP4000 1.2 spray gun, available from SATA GmbH & Co. KG, Kornwestheim, Germany, to form a clearcoat layer Comp 1. The substrate was spray coated at a horizontal position, flashed off horizontally for 10 minutes in the spray booth at 23 C and 60% relative humidity (RH) and finally the complete system was baked in a horizontal position for 30 minutes at 60 degrees Celsius, conventional heated, air oven temperature.

### Comparative 2

The same clearcoat coating composition, HC300 Imron® HydroClear 2K waterborne clearcoat, activated with HT-202 activator with 3/1 ratio, was spray coated over the above mentioned basecoat layer on the substrate using an ANEST IWATA WS-400 1.3 HD spray gun, available from Iwata Medea, Inc., Portland, Oreg., USA, to form a clearcoat layer Comp 2. The substrate was spray coated at a horizontal position, flashed off horizontally for 10 minutes in the spray booth at 23 C and 60% relative humidity (RH) and finally the complete system was baked in a horizontal position for 30 minutes at 60 degrees Celsius, conventional heated, air oven temperature.

### Experiment 1

The same clearcoat coating composition, HC300 Imron® HydroClear 2K waterborne clearcoat, activated with HT-202 activator with 3/1 ratio, was spray coated over the above mentioned basecoat layer on the substrate using the spray gun of this disclosure, to form a clearcoat layer Ex 1. The substrate was spray coated at a horizontal position, flashed off horizontally for 10 minutes in the spray booth at 23 C and 60% relative humidity (RH) and finally the complete system was baked in a horizontal position for 30 minutes at 60 degrees Celsius, conventional heated, air oven temperature.

Measurement of Coating Layer Property

Dullness, Longwave, Shortwave, Tension, Gloss, and DOI were measured with Byk—Gardner GMBH Wave-Scan-Dual AW-4840 according to instrument manufacturer's instruction. Clearcoat film thickness was measured using an ElektroPhysik Minitest 600 TM, available from ElektroPhysik Dr. Steingroever GmbH & Co. KG, Cologne, Germany, according to instrument manufacturer's instruction.

Popping limit was measured by: (1) spraying Cromax® Pro waterborne basecoat, available from Axalta Coating Systems under respective trademarks, to form a basecoat layer in 2 coats to 0.018 mm+/−0.002 mm, (2) then flashed the basecoat for 30 minutes at 22° C. and 60% RH (relative humidity), (3) the waterborne clearcoat was applied over the basecoat as a two coat wedge, 1 minute flash at booth settings between the first and the second coat wedge with a thickness ranging from 0.030 mm to 0.100 mm on a test panel, booth settings 22° C. at 60% RH, the subject was spray coated at a vertical position, flashed off vertically for 10 minutes in the spray booth at 23 C and 60% relative humidity (RH) and finally the complete system was baked in a vertical position for 30 minutes at 60 degrees Celsius, conventional heated, air oven temperature and (4) the clearcoat film thickness was measured at the onset of popping using the ElektroPhysik Minitest 600 TM.

Sag limit was measured by: (1) spraying Cromax® Pro waterborne basecoat to form a basecoat layer in 2 coats with a thickness at about 0.018 mm+/−0.002 mm, (2) then flashed the basecoat for 30 minutes at 22° C. at 60% RH, (3) Clearcoat was applied over the basecoat as a two coat wedge, 1 minute flash at booth settings between the coats to form the coat wedge with different film thickness ranging from about 0.03 mm to about 0.100 mm on a test panel with holes at regular intervals. The subject was spray coated at a vertical position, flashed off vertically for 10 minutes in the spray booth at 23 C and 60% relative humidity (RH) and finally the complete system was baked in a vertical position for 30 minutes at 60 degrees Celsius, conventional heated, air oven temperature, and (4) Clear coat film thickness was measured at the onset of sag using an ElektroPhysik Minitest 600 TM.

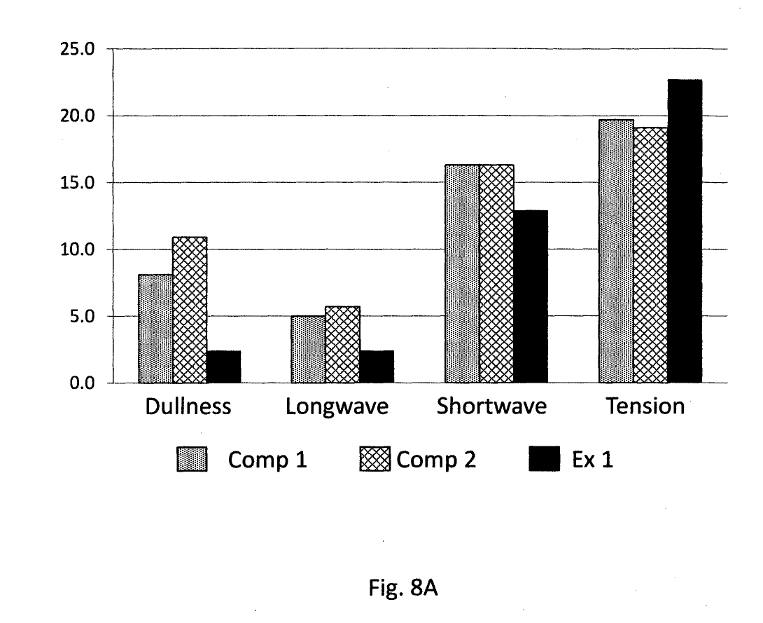

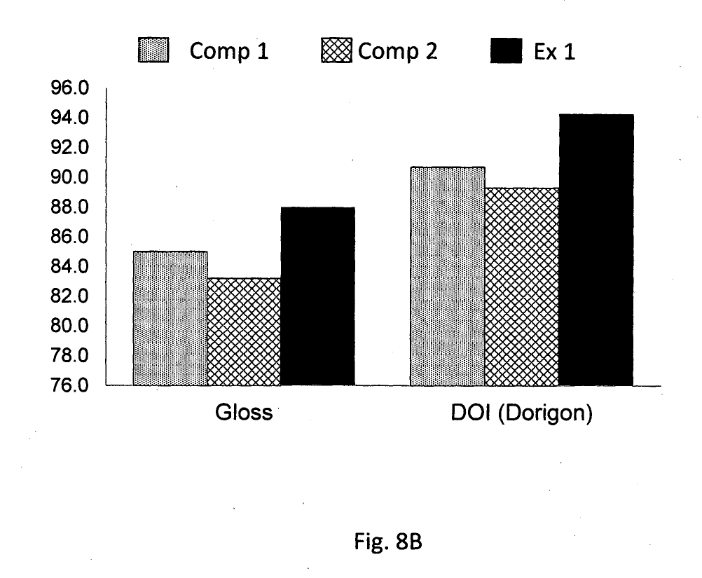

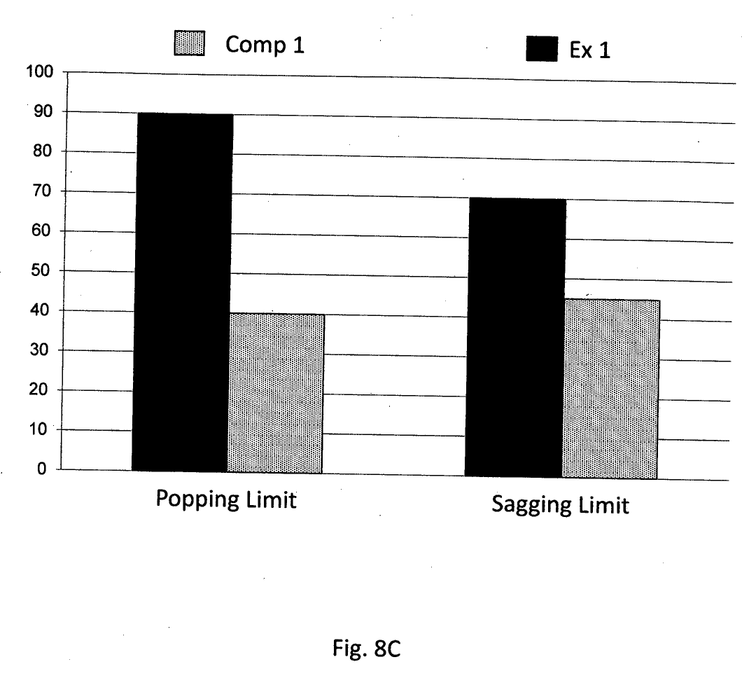

Measurement data are shown in FIG. 8A-8C.

In the following preferred embodiments are described in more detail.

Apparatus Embodiments:

In a first embodiment a spray gun comprising a spray gun body (1), an air cap (2), a fluid spray nozzle (3) having a fluid tip (4), at least one air distribution channel for atomizing air (8) and at least one air distribution channel for fan air (9) is provided, wherein the spray gun is characterized in that:

A) the fluid spray nozzle and the air cap are configured to direct an atomization air flow at an angle of about 15 to about 60 degrees, relative to the coating composition jet, into the coating composition jet, and

B) the fluid spray nozzle and the air cap are configured to provide an atomizing air pressure to fan air pressure ratio of about 0.5 to about 1.0.

According to a second embodiment in the spray gun of the first embodiment the fluid spray nozzle and the air cap are configured to direct an atomization air flow at an angle of about 30 to about 45 degrees, relative to the coating composition jet, into the coating composition jet.

According to a third embodiment in the spray gun of the first or the second embodiment the fluid spray nozzle and the air cap are configured to provide an atomizing air pressure to fan air pressure ratio of about 0.6 to about 0.9.

According to a fourth embodiment in the spray gun of any one of the first to third embodiment the air cap contains horns for the fan air.

According to a fifth embodiment in the spray gun of any one of the first to fourth embodiment the air cap and the fluid spray nozzle contain additional bores to direct the atomizing air flow.

According to a sixth embodiment in the spray gun of any one of the first to fifth embodiment an atomizing air pressure of about 1.0 to about 5.0 bar, measured at the air cap outlet, is used in the operation mode of the spray gun.

According to a seventh embodiment in the spray gun of any one of the first to sixth embodiment a fan air pressure is of about 1.0 to about 5.0 bar, measured at the air cap outlet, is used in the operation mode of the spray gun.

According to an eighth embodiment in the spray gun of any one of the first to seventh embodiment a fan air pressure is of about 2.0 to about 4.0 bar, measured at the air cap outlet, and an atomizing air pressure of about 2.0 to about 4.0 bar, measured at the air cap outlet, are used in the operation mode of the spray gun.

According to a ninth embodiment in the spray gun of any one of the first to eighth embodiment it contains means for regulating the atomizing and fan air volume.

According to a tenth embodiment in the spray gun of any one of the first to ninth embodiment it is a manual spray gun.

According to an eleventh embodiment a fluid spray nozzle/air cap assembly is provided, wherein A) the fluid spray nozzle and the air cap are configured to direct an atomization air flow at an angle of about 15 to about 60 degrees, relative to the coating composition jet, into the coating composition jet, and B) the fluid spray nozzle and the air cap are configured to provide an atomizing air pressure to fan air pressure ratio of about 0.5 to about 1.0.

According to a twelfth embodiment in the fluid spray nozzle/air cap assembly of embodiment eleven the fluid spray nozzle and the air cap are configured to direct an atomization air flow at an angle of about 30 to about 45 degrees, relative to the coating composition jet, into the coating composition jet.

According to embodiment 13 the use of the spray gun of any one of the first to tenth embodiment for applying water-based coating compositions and/or for applying water-based clear coat coating compositions is provided.

According to embodiment 14 the use of embodiment 13 for applying water-based clear coat coating compositions is provided.

According to embodiment 15 the use of embodiment 13 for applying water-based clear coat coating compositions and water-based basecoat coating compositions is provided.

According to embodiment 16 the use of the fluid spray nozzle/air cap assembly of embodiment eleven or twelve for applying water-based coating compositions is provided.

Method Embodiments:

According to embodiment 17 a method for applying a layer of a water-based coating composition onto a substrate by a spray gun is provided, said method comprising the steps of:

(1) providing a spray gun, said spray gun comprising a spray gun body (1), an air cap (2), a fluid spray nozzle (3) having a fluid tip (4), at least one air distribution channel for atomizing air (8) and at least one air distribution channel for fan air (9), wherein the spray gun is characterized in that: A) the fluid spray nozzle and the air cap are configured to direct an atomization airflow at an angle of about 15 to about 60 degrees, relative to the coating composition jet, into the coating composition jet, and

B) the fluid spray nozzle and the air cap are configured to provide an atomizing air pressure to fan air pressure ratio of about 0.5 to about 1.0.;

(2) applying at least one layer of the water-based coating composition onto the substrate by said spray gun, wherein the water-based coating composition is applied with an atomizing air pressure to fan air pressure ratio of about 0.5 to about 1.0.

According to embodiment 18 in the method of embodiment 17 the fluid spray nozzle and the air cap are configured to direct an atomization air flow at an angle of about 30 to about 45 degrees, relative to the coating composition jet, into the coating composition jet.

According to embodiment 19 in the method of embodiment 17 or 18 the fluid spray nozzle and the air cap are configured to provide an atomizing air pressure to fan air pressure ratio of about 0.6 to about 0.9.

According to embodiment 20 in the method of any one of embodiments 17 to 19 the air cap of the spray gun contains horns for the fan air.

According to embodiment 21 in the method of any one of embodiment 17 to 20 the air cap and the fluid spray nozzle of the spray gun contain additional bores to direct the atomizing air flow.

According to embodiment 22 in the method of any one of embodiment 17 to 21 the water-based coating composition is applied with an atomizing air pressure to fan air pressure ratio of about 0.6 to about 0.9.

According to embodiment 23 in the method of any one of embodiment 17 to 22 the water-based coating composition is applied with an atomizing air pressure of about 1.0 to about 5.0 bar, measured at the air cap outlet.

According to embodiment 24 in the method of any one of embodiment 17 to 23 the water-based coating composition is applied with a fan air pressure of about 1.0 to about 5.0 bar, measured at the air cap outlet.

According to embodiment 25 in the method of any one of embodiment 17 to 24 the water-based coating composition is applied with a fan air pressure of about 2.0 to about 4.0 bar, measured at the air cap outlet and an atomizing air pressure of about 2.0 to about 4.0 bar, measured at the air cap outlet.

According to embodiment 26 in the method of any one of embodiment 17 to 25 the spray gun contains means for regulating the atomizing and fan air volume.

According to embodiment 27 in the method of any one of embodiment 17 to 26 the spray gun is handled manually, by a spraying robot or by a spraying machine.

According to embodiment 28 in the method of any one of embodiment 17 to 27 the spray gun is a manual spray gun.

According to embodiment 29 in the method of any one of embodiment 17 to 28 a water-based clear coat coating composition is applied in step (2).

According to embodiment 30 in the method of any one of embodiment 17 to 29 a water-based base coat coating composition is applied in step (2).

According to embodiment 31 in the method of any one of embodiment 17 to 30 a water-based base coat coating composition is applied and subsequently a water-based clear coat coating composition is applied over the water-based base coat coating composition.

According to embodiment 32 the method of any one of embodiment 17 to 31 further comprises the step (3) curing the water-based coating composition.

According to embodiment 33 the use of the method of any one of embodiment 17 to 32 in vehicle repair coating is presented.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the application in any way. Rather, the foregoing detailed description will provide those skilled in the art with a convenient road map for implementing one or more exemplary embodiments, it being understood that various changes may be made in the function and arrangement of elements described in an exemplary embodiment without departing from the scope as set forth in the appended claims and their legal equivalents.

1. A spray gun comprising a spray gun body, an air cap, a fluid spray nozzle having a fluid tip, at least one air distribution channel for atomizing air and at least one air distribution channel for fan air, wherein the spray gun is characterized in that:
A) the fluid spray nozzle and the air cap are configured to direct an atomization air flow at an angle of about 10 to about 70 degrees, relative to a coating composition jet, into the coating composition jet.

2. The spray gun of claim 1, wherein the spray gun is characterized in that:
B) the fluid spray nozzle and the air cap are configured to provide an atomizing air pressure to fan air pressure ratio of about 0.1 to about 10.

3. The spray gun of claim 1, wherein the fluid spray nozzle and the air cap are configured to direct the atomization air flow at an angle of about 30 to about 45 degrees, relative to the coating composition jet, into the coating composition jet.

4. The spray gun of claim 1, wherein the fluid spray nozzle and the air cap are configured to provide an atomizing air pressure to fan air pressure ratio of about 0.6 to about 0.9.

5. The spray gun of claim 1, wherein the air cap contains horns for the fan air.

6. The spray gun of claim 1, wherein the air cap and the fluid spray nozzle contain additional bores to direct the atomizing air flow.

7. The spray gun of claim 1, wherein an atomizing air pressure of about 0.5 to about 5.0 bar, measured at the air cap outlet, is used in an operation mode of the spray gun.

8. The spray gun of claim 1, wherein a fan air pressure of about 1.0 to about 5.0 bar, measured at the air cap outlet, is used in an operation mode of the spray gun.

9. The spray gun of claim 1, wherein a fan air pressure of about 2.0 to about 4.0 bar, measured at the air cap outlet, and an atomizing air pressure of about 2.0 to about 4.0 bar, measured at the air cap outlet, are used in an operation mode of the spray gun.

10. The spray gun of claim 1, wherein the spray gun contains means for regulating an atomizing and fan air volume.

11. The spray gun of claim 1, wherein the spray gun is a manual spray gun.

12. A fluid spray nozzle/air cap assembly, wherein A) the fluid spray nozzle and the air cap are configured to direct an atomization air flow at an angle of about 10 to about 70 degrees, relative to a coating composition jet, into the coating composition jet, and B) the fluid spray nozzle and the air cap are configured to provide an atomizing air pressure to fan air pressure ratio of about 0.1 to about 10.

13. The fluid spray nozzle/air cap assembly of claim 12, wherein the fluid spray nozzle and the air cap are configured to direct the atomization air flow at an angle of about 30 to about 45 degrees, relative to the coating composition jet, into the coating composition jet.

14. Use of the spray gun of claim 1 for applying one or more of water-based coating compositions and water-based clear coat coating compositions.

15. A method for applying a layer of a water-based coating composition onto a substrate by a spray gun, said method comprising the steps of:
(1) providing a spray gun, said spray gun comprising a spray gun body, an air cap, a fluid spray nozzle having a fluid tip, at least one air distribution channel for atomizing air and at least one air distribution channel for fan air, wherein the spray gun is characterized in that:
A) the fluid spray nozzle and the air cap are configured to direct an atomization airflow at an angle of about 10 to about 70 degrees, relative to a coating composition jet, into the coating composition jet, and
B) the fluid spray nozzle and the air cap are configured to provide an atomizing air pressure to fan air pressure ratio of about 0.1 to about 10.
(2) applying at least one layer of the water-based coating composition onto the substrate by said spray gun, wherein the water-based coating composition is applied with the atomizing air pressure to fan air pressure ratio of about 0.1 to about 10.

16. The method of claim 15, wherein the water-based coating composition is applied with the atomizing air pressure to fan air pressure ratio of about 0.6 to about 0.9.

17. The method of claim 15, wherein the water-based coating composition is applied with an atomizing air pressure of about 0.5 to about 5.0 bar, measured at the air cap outlet.

18. The method of claim 15, wherein the water-based coating composition is applied with a fan air pressure of about 0.5 to about 5.0 bar, measured at the air cap outlet.

19. The method of claim 15, wherein the water-based coating composition is applied with a fan air pressure of about 2.0 to about 4.0 bar, measured at the air cap outlet and an atomizing air pressure of about 2.0 to about 4.0 bar, measured at the air cap outlet.

20. The method of claim 15, wherein the spray gun is handled manually, by a spraying robot or by a spraying machine.

21. The method of claim 15, wherein the water-based coating composition applied in step (2) is selected from the group consisting of a water-based clear coat coating composition, or a water-based base coat coating composition.

22. The method of claim 15, wherein applying a water-based coating composition comprises applying a water-based base coat coating composition and subsequently applying a water-based clear coat coating composition over the water-based base coat coating composition.

23. The method of claim 15, further comprising: (3) curing the water-based coating composition.

24. A method for producing a coating layer over a substrate with a coating composition, the method comprising the steps of:
(1) atomizing the coating composition from a fluid spray nozzle and air cap assembly comprising an air cap and a fluid spray nozzle having a fluid tip orifice, to form an atomized coating composition jet by directing an atomizing air to form an atomization air flow evenly in a rotational symmetry around a rotational axis Z-Z′ of the fluid spray nozzle and all around the fluid tip orifice at an atomization air flow angle in a range of from about 10 to about 70 degrees, relative to the rotational axis Z-Z′; and
(2) spraying the atomized coating composition jet over the substrate to form the coating layer.
